(19) United States
(12) Patent Application Publication
(10) Pub. No.: US 2011/0040030 A1
(43) Pub. Date: Feb. 17, 2011

(54) USE OF A CYCLOHEXANE DIOL MIXTURE FOR MANUFACTURING POLYMERS

(75) Inventors: Darijo Mijolovic, Mannheim (DE); Sebastien Garnier, Weinheim (DE); Qiang Miao, Mannheim (DE); Maria Guixa Guardia, Mannheim (DE); Gerd-Dieter Tebben, Mannheim (DE); Dag Wiebelhaus, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/989,800

(22) PCT Filed: May 12, 2009
(86) PCT No.: PCT/EP2009/055688

§ 371 Date: Oct. 27, 2010

(30) Foreign Application Priority Data
May 14, 2008 (EP) 08156169.8

(51) Int. Cl. C08L 73/00; C08G 65/34; C08G 64/00; C08G 69/14; C08G 63/08

(52) U.S. Cl. 524/612; 528/425; 528/370; 528/323; 528/354

(57) ABSTRACT

A polymer obtainable by polycondensation or polyaddition from monomeric compounds, wherein one monomeric compound used is a mixture of hydroxymethylcyclohexanepropanol or its alkoxylated derivatives and hydroxymethylcyclohexaneisopropanol or its alkoxylated derivatives (referred to below for short as C1/C3 cyclohexanediol mixture).

The invention relates to a polymer obtainable by polycondensation or polyaddition from monomeric compounds, where one monomeric compound used is a mixture of hydroxymethylcyclohexanepropanol or its alkoxylated derivatives and hydroxymethylcyclohexaneisopropanol or its alkoxylated derivatives (referred to below for short as C1/C3 cyclohexanediol mixture).

Diols are needed for preparing polymers, of which examples are polyesters or polyurethanes. EP-A 562 578 describes the use of various cyclohexanediols such as 1,4-cyclohexanedimethanol or 1,4-cyclohexanediethanol for preparing polyesters. From DE-A 31 19 380 the use of hydroxymethylhydroxypropylcyclohexane for polyesters is also known.

Mixtures of different hydroxymethylhydroxypropylcyclohexanes are obtainable by hydroformylation of vinylcyclohexene and subsequent hydrogenation; one process of this kind is described in DE-A 1032 241.

In principle, there is a desire to improve the performance properties of polymers in their various applications.

Where the polymers are used as binders in coating materials, adhesives or sealants, a particularly important factor is the viscosity, whether in the form of the melt viscosity (100% systems) or the solution viscosity (polymer solutions). For coatings applications the coatings produced ought to have good mechanical properties, such as impact strength and elasticity, high scratch resistance and impact resistance, high stability to water, solvents, fats, chemicals, and environment effects, and also high gloss.

It was an object of the present invention to provide such polymers.

Found accordingly have been the polymers defined at the outset and also their use as binders in coating materials, sealants or adhesives.

The C1/C3 cyclohexanediol mixture

The polymer of the invention is prepared using, in addition to other monomeric compounds, a mixture which is composed of hydroxymethylcyclohexanepropanol and hydroxymethylcyclohexaneisopropanol; the above diols may also be present in the form of their alkoxylated derivatives and may be used in that form (referred to collectively below for short as C1/C3 cyclohexanediol mixture).

In the text below, for all of the stated diols of the C1/C3 mixture, the intention is that in all cases the alkoxylated derivatives should be included as well. The diols may be alkoxylated in particular with ethylene oxide or propylene oxide or else mixtures thereof; the alcohol groups may be alkoxylated with, for example, 1 to 20, more particularly 1 to 10, alkyoxy groups.

In one preferred embodiment the diols of the C1/C3 mixture of the invention are not alkoxylated.

The hydroxymethylcyclohexanepropanol may be

3-hydroxymethylcyclohexanepropanol of the formula I

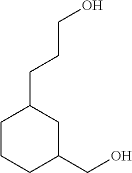

### Or

4-hydroxymethylcyclohexanepropanol of the formula II

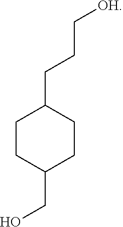

3-Hydroxymethylcyclohexanepropanol may be present in two diastereomeric forms and/or 4 enantiomeric forms (two stereocenters: RR, SS, RS and SR) or in the form of any desired mixture of these forms.

4-Hydroxymethylcyclohexanepropanol may be present in two diastereomeric forms (no stereocenter, two stereoisomers: cis and trans) or as a mixture of these forms.

The hydroxymethylcyclohexaneisopropanol may be

3-hydroxymethylcyclohexaneisopropanol of the formula III

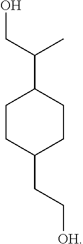

or 4-hydroxymethylcyclohexaneisopropanol of the formula IV

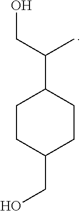

3-Hydroxymethylcyclohexaneisopropanol may be present in four diastereomeric forms and/or eight enantiomeric forms (3 stereocenters: RRR, SSS, RRS, SSR, RSR, SRS, RSS and SRR) or in the form of any desired mixture of these forms.

4-Hydroxymethylcyclohexaneisopropanol may be present in two diastereomeric forms and/or 4 enantiomeric forms (one stereocenter: R-trans, S-trans, R-cis and S-cis) or in the form of any desired mixture of these forms.

The C1/C3 cyclohexanediol mixture comprises preferably 5% to 95%, more preferably 10% to 90%, and very preferably 20% to 80% by weight of hydroxymethylcyclohexanepropanol (3-hydroxymethylcyclohexanepropanol or 4-hydroxymethylcyclohexanepropanol or mixtures thereof) and 5% to 95%, more preferably 10% to 90%, and very preferably 20% to 80% by weight of hydroxymethylcyclohexaneisopropanol (3-hydroxymethylcyclohexaneisopropanol or 4-hydroxymethylcyclohexaneisopropanol or mixtures thereof), the percentages being based on the weight sum of the stated diols.

Preferably the C1/C3 cyclohexanediol mixture comprises all four above diols, namely 3-hydroxymethylcyclohexanepropanol, 4-hydroxymethylcyclohexanepropanol, 3-hydroxymethylcyclohexaneisopropanol, and 4-hydroxymethylcyclohexane-isopropanol.

With particular preference the C1/C3 cyclohexanediol mixture comprises

5% to 85%, more particularly 10% to 40%, by weight of 3-hydroxymethylcyclohexane-propanol,
5% to 85%, more particularly 10% to 40%, by weight of 4-hydroxymethylcyclohexane-propanol,
5% to 85%, more particularly 10% to 40%, by weight of 3-hydroxymethylcyclohexane-isopropanol, and
5% to 85%, more particularly 10% to 40%, by weight of 4-hydroxymethylcyclohexane-isopropanol,
the weight percentages being based on the weight sum of the four diols.

The preparation of the C1/C3 cyclohexanediol mixture

In the preparation of the polymer, the diols of the C1/C3 cyclohexane mixture may be used in any form, and may also be used separately. The essential factor is that the polymer comprises the corresponding diols.

The C1/C3 cyclohexanediol mixture is preferably prepared beforehand and used as a mixture for preparing the polymer.

The C1/C3 cyclohexanediol mixture can be prepared in any desired way. For example, the monomeric compounds can be synthesized individually and then mixed in the desired proportions.

The C1/C3 cyclohexanediol mixture is obtainable more particularly by hydroformylation of 4-vinylcyclohexene and subsequent hydrogenation; with particular preference the mixture thus obtained is then used for preparing the polymers.

Addition of carbon monoxide (CO) and hydrogen (H₂) to both double bonds of the 4-vinylcyclohexene (hydroformylation) and subsequent hydrogenation produces a mixture which comprises the above 4 compounds of the formulae I to IV.

The resulting C1/C3 cyclohexanediol mixture may if desired also comprise further constituents, especially other cyclohexane derivatives with hydroxyl groups.

The mixture obtained in the hydroformylation is generally composed of at least 90% by weight of the C1/C3 cyclohexanediol mixture used in accordance with the invention, and can be used in that form.

Processes for preparing alcohols via hydroformylation and hydrogenation of olefins are described in large numbers in the literature.

The choice of the catalyst system and of the optimum reaction conditions are dependant on the reactivity of the unsaturated compound employed.

The effect of the structure of the olefin used on its reactivity in hydroformylation is described by, for example, J. Falbe, “New Syntheses with Carbon Monoxide”, Springer Verlag, 1980, Berlin, Heidelberg, N.Y.

The hydroformylation may be carried out in particular with modified and/or unmodified rhodium catalysts. The hydroformylation may take place in accordance with the prior art, as is described in EP-A 0213639, EP-A 0214622, WO 2004/020380 or WO 2004/024661, for example. After the catalyst has been removed by extraction, absorption or distillation, hydrogenation may take place under the conditions described above to give the corresponding alcohols.

For the hydrogenation it is possible to make use, for example, of nickel, copper, copper/nickel, copper/chromium, copper/chromium/nickel, zinc/chromium or nickel/molybdenum catalysts. The catalysts may be unsupported, or the actively hydrogenating substances and/or their precursors may be applied to supports, such as SiO₂ or Al₂O₃, for example. The hydrogenation is carried out as a liquid-phase hydrogenation at a pressure of 0.5-50 MPa. The reaction temperatures are in the range of 100-220° C., preferably 140-180° C. Examples of such hydrogenations are described in DE-A 19842369 and DE-A 19842370, for example.

The process can be carried out batchwise or, preferably, continuously.

### The Polymers

The polymers are obtainable by polycondensation or polyaddition from monomeric compounds, using the C1/C3 cyclohexanediol mixture; if desired, the polymers may be chemically modified—for example functionalized or crosslinked—means of other or further reactions.

In the polycondensation of monomeric compounds there is elimination of water or alcohol; in the case of polyaddition, there is no elimination.

Preferred polycondensates are polyesters, which are obtainable by reaction of diols or polyols with dicarboxylic or polycarboxylic acids, which may also be used in the form of reactive derivatives, such as anhydrides or esters.

By polyester is meant below a polymer which is composed of more than 50%, more preferably of more than 70%, and in particular of more than 90%, by weight of synthesis components selected from diols, polyols, dicarboxylic acids, and polycarboxylic acids.

Mention may also be made of polycarbonate diols, which are obtainable by reacting dialkyl carbonates with diols, with elimination of alcohols.

One polyadduct that may be mentioned in particular is polyurethane. Also suitable, for example, are polyadducts obtainable by ring-opening polymerization of lactones or lactams.

A polyurethane below is a polymer which is composed of more than 50%, more preferably of more than 70%, and in particular of more than 90% by weight of synthesis components selected from diisocyanates, polyisocyanates, diols and polyols.

A feature common to all of these polymers is that they are synthesized essentially from diols and from compounds that are reactive with these diols, such as dicarboxylic and/or polycarboxylic acids (polyesters) or diisocyanates and/or polyisocyanates (polyurethanes).

Preferred polymers are polyesters and polyurethanes, with polyesters being particularly preferred.

The polymers of the invention preferably have the C1/C3 cyclohexanediol mixture content below; the weight figures below pertaining to the amount of the C1/C3 cyclohexanediol mixture in the polymer refer to the units of the polymer that derive from the C1/C3 cyclohexanediol mixture. In the case of polyadducts, the weight of these units corresponds unchanged to the C1/C3 cyclohexanediol mixture; in the case of polycondensates, the weight of these units is reduced by the hydrogen atoms of the hydroxyl groups.

Preferred polymers are composed of at least 0.5%, more preferably at least 2%, very preferably at least 5%, and more particularly at least 10% by weight, and in one particular embodiment at least 20% by weight, of the C1/C3 cyclohexanediol mixture. Since the use of other compounds reactive with the diols is mandatory, the polymers are generally composed of not more than 70%, more particularly not more than 60% or not more than 50%, by weight of the C1/C3 cyclohexanediol mixture.

Besides the C1/C3 cyclohexanediol mixture, the polymers may also comprise other diols or polyols as synthesis components. In one preferred embodiment at least 10%, more preferably at least 25%, and very preferably at least 50% by weight of the diols and polyols of which the polymers are composed comprises the C1/C3 cyclohexanediol mixture.

More particularly at least 70% by weight or at least 90% by weight of the diols and polyols of which the polymers are composed may comprise the C1/C3 cyclohexanediol mixture.

In one particular embodiment 100% by weight of all of the diols and polyols of which the polymers are composed comprises the C1/C3 cyclohexanediol mixture.

### Further Constituents of the Polyesters

Besides the C1/C3 cyclohexanediol mixture, polyester may comprise further diols or polyols as synthesis components.

Diols include, for example, ethylene glycol, propylene glycol, and their counterparts with higher degrees of condensation, such as diethylene glycol, triethylene glycol, dipropylene glycol, tripropylene glycol etc., for example, butanediol, pentanediol, hexanediol, neopentyl glycol, alkoxylated phenolic compounds, such as ethoxylated and/or propoxylated bisphenols, cyclohexanedimethanol; polyols suitable as a further synthesis component are trifunctional and higher polyfunctional alcohols, such as glycerol, trimethylolpropane, butanetriol, trimethylolethane, pentaerythritol, neopentyl glycol, ditrimethylolpropane, dipentaerythritol, sorbitol, and mannitol.

The above diols or polyols may be alkoxylated, more particularly ethoxylated and propoxylated. The alkoxylation products are obtainable in a known way by reaction of the above alcohols with alkylene oxides, in particular ethylene oxide or propylene oxide. The degree of alkoxylation per hydroxyl group is preferably 0 to 10, i.e., 1 mol of hydroxyl group may be alkoxylated preferably with up to 10 mol of alkylene oxides.

The polyesters further comprise dicarboxylic acids or polycarboxylic acids as synthesis components. For the preparation of the polyesters, dicarboxylic acids or polycarboxylic acids may also be used in the form of their reactive derivatives, such as anhydrides or esters, for example. Suitable dicarboxylic acids are succinic acid, glutaric acid, adipic acid, sebacic acid, isophthalic acid, terephthalic acid, their isomers and hydrogenation products, such as tetrahydrophthalic acid. Also suitable are maleic acid and fumaric acid for unsaturated polyesters.

Polyesters may also comprise monoalcohols or monocarboxylic acids as a constituent; through the accompanying use of such compounds, the molecular weight can be adjusted, or limited.

In order to achieve particular properties, the polyesters may comprise particular functional groups. Water-soluble or water-dispersible polyesters comprise the necessary amount of hydrophilic groups, carboxyl groups or carboxylate groups, for example, in order to achieve solubility in water or dispersibility in water. Crosslinkable polyesters, for powder coating materials, for example, comprise functional groups which enter into a crosslinking reaction with the crosslinking agent that is used. These may likewise be carboxylic acid groups, if crosslinking is intended with compounds comprising hydroxyl groups, such as hydroxyalkylamides, for example. The functional groups may also be ethylenically unsaturated groups, as a result, for example, of modification of the polyester with unsaturated dicarboxylic acids (maleic acid) or reaction with (meth)acrylic acid; polyesters of this kind are radiation-curable.

### Further Constituents of the Polyurethanes

Polyurethanes comprise as an essential synthesis component diisocyanates or polyisocyanates.

Mention may be made in particular of diisocyanates X(NCO)₂, where X is an aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis, and the cis/trans isomer, and also mixtures of these compounds.

Diisocyanates of this kind are available commercially.

Particularly important mixtures of these isocyanates are the mixtures of the respective structural isomers of diisocyanatotoluene and diisocyanatodiphenylmethane, a particularly suitable mixture being that of 80 mol % 2,4-diisocyanatotoluene and 20 mol % 2,6-diisocyanatotoluene. Also particularly advantageous are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred mixing ratio of the aliphatic to the aromatic isocyanates is 4:1 to 1:4.

Diols and/or polyols which are reacted with the diisocyanates or polyisocyanates are, in accordance with the invention, the C1/C3 cyclohexanediol mixture, used alone or in a mixture with other diols or polyols.

In the case of polyurethanes the diols used preferably include polyesterdiols. Such polyesterdiols are obtained beforehand by reaction of diols or polyols with dicarboxylic or polycarboxylic acids (see description of the polyesters above). The C1/C3 cyclohexanediol mixture may be present in the polyurethanes in the form of such polyesterdiols. Further diols and polyols are those identified above, either as synthesis components which are reacted directly with the diisocyanates or polyisocyanates, or as a constituent of the polyesterdiols. Suitable dicarboxylic acids or polycarboxylic acids for the polyesterdiols are likewise those identified above.

The polyurethanes may also include monoalcohols or monoisocyanates as constituents; the molecular weight can be adjusted, or limited, through the accompanying use of such compounds.

In order to achieve particular properties, the polyurethanes may comprise particular functional groups. Water-soluble or water-dispersible polyurethanes comprise the necessary amount of hydrophilic groups, carboxyl groups or carboxylate groups, for example, in order to achieve solubility in water or dispersibility in water. An example of a suitable synthesis component is dimethylolpropionic acid. Crosslinkable polyurethanes comprise functional groups which are able to enter into a crosslinking reaction with the crosslinking agent that is used. Besides urethane groups, the polyurethanes may also, in particular, comprise other functional groups, urea groups for example, which come about through reaction of the diisocyanates or polyisocyanates with amino compounds.

If desired, the polymers can be chemically modified by other or further reactions, such as functionalized or crosslinked, for example, at or else, in particular, at a later point in time, as for example in the course of use.

In particular the polymers may comprise crosslinking groups, which, when the necessary conditions are present, enter into a crosslinking reaction. The polymers may in particular also be used in a mixture with crosslinkers which at the desired point in time, under the necessary conditions (in particular, at elevated temperature), enter into a crosslinking reaction with the polymer.

According to the reactivity of the crosslinkers, a distinction is made between one-component (1K) and two-component (2K) systems. In the case of 2K systems, the crosslinker is not added until shortly before subsequent use; in the case of 1K systems, the crosslinker can be added to the system at an early stage (latent crosslinker), with crosslinking only taking place under the conditions that are brought about later on, such as when solvent is removed and/or temperature is raised, for example.

Typical crosslinkers are, for example, isocyanates, epoxides, acid anhydrides or else, in the case of polymers containing free-radically polymerizable ethylenically unsaturated groups, ethylenically unsaturated monomers such as styrene.

### The Use of the Polymers

The polymers are suitable as a constituent of thermoplastic compositions. The polymers, polyesters or polyurethanes for example, preferably have a sufficiently high molecular weight for this purpose, so that they have thermoplastic properties.

Thermoplastic compositions are generally used for producing moldings, in which case typical processes such as injection molding, extrusion or blow molding may be employed.

More particularly the polymers are suitable as a constituent of coating materials, sealants or adhesives.

The coating materials, sealants or adhesives comprise the polymers of the invention preferably as binders. They may comprise further binders and other additives, examples being antioxidants, stabilizers, dyes, pigments, flow control agents, thickeners or wetting assistants.

The coating materials, sealants or adhesives may be aqueous or solventborne compositions. Such compositions comprise the binders of the invention preferably in the form of solutions or dispersions in water or organic solvents or mixtures thereof. Where necessary, the polymers comprise additional functional groups which bring about solubility or dispersibility in water or organic solvents (see above).

The coating materials, sealants or adhesives may be compositions which are largely free of water or organic solvents (known as 100% systems). Compositions of this kind generally comprise less than 10 parts by weight of water or other organic solvents (boiling point less than 150° C. at 1 bar) per 100 parts by weight of the compositions. With particular preference they comprise less than 2 parts, very preferably less than 1 part, or less than 0.5 part, by weight of water or other organic solvent (boiling point less than 150° C. at 1 bar) per 100 parts by weight of the compositions.

The compositions in question may be compositions which are still fluid at room temperature or may be compositions which take the form, for example, of a powder and are processed only at elevated temperatures.

The compositions, more particularly coating materials, may be radiation-curable and may be used as radiation-curable compositions or coating materials. For this purpose they preferably comprise a radiation-curable polymer of the invention, more particularly a radiation-curable polyester (see above). Radiation curing may take place with high-energy radiation, examples being electron beams or UV light; if UV light is used, it is possible with preference to add a photoinitiator to the polymers.

One preferred use in the context of the present invention is the use of the polymers of the invention as or in powder coating materials. As a powder coating material it is preferred to use polyesters which are crosslinkable.

In one preferred embodiment the powder coating material is prepared by mixing and melting the polyester, crosslinker, and further additives, pigments and flow control agents, for example, at high temperatures. The mixture can be brought into powder form by subsequent extrusion and corresponding processing of the extrudate.

The powder coating material can be applied to the desired substrates, examples being those having surfaces of metal, plastic or wood, in a typical manner, including, for example, electrostatically.

The polymers of the invention have a low viscosity, either a low melt viscosity (100% systems) or a low solution viscosity (polymer solutions). The low viscosity permits ease of handling, produces good coating properties, and permits higher solids contents in solutions or dispersions, or lower binder fractions in compositions comprising pigment.

When used in coating materials, sealants, and adhesives, the polymers of the invention have the effect of good mechanical properties; more particularly, the coating materials, powder coating materials for example, have high impact strength, good elasticity, and good gloss.

### EXAMPLES

### Preparation of the C1/C3 cyclohexanediol mixture

1 kg of a 1:1 mixture of vinylcyclohexene/toluene is admixed with 10 ppm of Rh(acac)(CO)₂ and the mixture is heated to 120° C. in a stirred autoclave. A synthesis gas (1:1 CO/H₂) pressure of 600 bar is set. After 10 h, the reaction mixture was cooled and let down.

The crude discharge was subsequently hydrogenated at 170° C. under a hydrogen pressure of 280 bar, in trickle mode, over a 1:1 mixture of a fixed-bed catalyst containing Ni/Mo and containing Co/Cu/Mo. The resulting C1/C3 cyclohexanediol mixture contained the four diols below in the quantities stated.

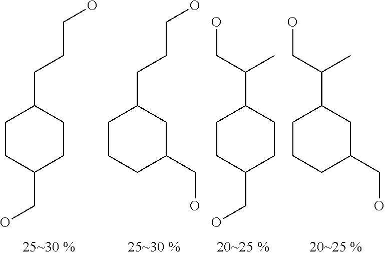

### Preparation of the Polymers

### Abbreviations

ADS: adipic acid
D: polydispersity index (M_{w}/Mₙ)
DPG: dipropylene glycol
DBTO: dibutyltin oxide
CHA: C1/C3 cyclohexanediol mixture from preparation example
DSC: differential scanning calorimetry
GPC: gel permeation chromatography
IPS: isophthalic acid
Mₙ: number-average molecular weight [g/mol]
M_{w}: weight-average molecular weight [g/mol]
nVC: nonvolatiles content
NPG: neopentyl glycol
OHN: OH number
AN: acid number
T_{g}: glass transition temperature
TMP: trimethylolpropane
TMAA: trimellitic acid anhydride
TPA: terephthalic acid
η₁: melt viscosity
η₂: solution viscosity

### Polymer Characterization Methods

The molecular weight determinations are carried out with GPC. Stationary phase: highly crosslinked porous polystyrene-divinylbenzene, available commercially as PL-GEL from Polymer Laboratories. Eluent: THF. Flow rate: 0.3 ml/min. Calibration with polyethylene glycol 28700 to 194 daltons from PSS.

The acid number of the polyesters is determined by the DIN standard method 53169. The melt viscosity η₁ of the polyesters is determined using a cone/plate viscosimeter at 200° C. in rotation mode and with a shear rate of 3400 s⁻¹. The solution viscosity η₂ of the polyesters is determined using a cone/plate viscosimeter at room temperature in rotation mode. The solutions are composed of 70% polyester and 30% solvent (mixture of Solvesso 100™/Solvenon PM™ 5/1).

The Tg of the polyesters is determined by means of DSC in accordance with ASTM D3418.

### Preparation of Powder Polyesters with COOH Groups

### Polyester P1

### Stage I—Preparation of the OH-Containing Oligomer

210.1 g of CHA (1.22 mol), 139.8 g of NPG (1.34 mol), 40.9 g of TMP (0.31 mol), 405.6 g of TPA (2.44 mol), and 0.5 g DBTO catalyst are charged to a 2 L four-neck flask equipped with thermometer, inert gas inlet, stirrer, and reflux condenser. With a stream of nitrogen being passed through the flask, and under reflux, the mixture of reactants is heated rapidly to 180° C. Water is distilled off continuously. Subsequently the reaction mixture is heated in stages to 230° C. over the course of 3 to 5 hours, with stirring and with the flow of nitrogen maintained, and is stirred further at 230° C. until the oligomer has an AN of 10 to 15 mg KOH/g. The AN of the oligomer is 11 mg KOH/g.

Stage II—Preparation of the COOH-Containing Polymer P1

The oligomer synthesized above is cooled to 180° C. and then 101.4 g of IPA (0.61 mol) are added. The temperature is raised to 230° C., and condensation continues under these conditions until the polymer has an AN of 30 to 40 mg KOH/g. The water produced by the polymerization can be stripped off at the end of the reaction by a gentle vacuum, in order to achieve the desired AN. The product is a branched, COOH-containing powder polyester P1 whose AN is 32 mg KOH/g. P1 has a glass transition temperature T_{g} of 69° C. and a melt viscosity η₁ of 14.0 Pa·s at 200° C. The GPC analysis yields the following values: Mₙ=2970 g/mol; D=11.0 (see Table 1).

Polyesters P2 to P5

The same procedure as for the preparation of P1 is repeated, using the compositions summarized in Table 1. The products are branched, COOH-containing powder polyesters whose characteristic data—AN, Mₙ, D, T_{g} and η₁—are listed in Table 1.

TABLE 1

| | Composition | | | | | Key polyester data | | | | |
|---|---|---|---|---|---|---|---|---|---|---|
| Poly- | CHA | NPG | TMP | TPA | IPA | AN | Mₙ | | T_{g} | η₁ |
| ester | [g] | [g] | [g] | [g] | [g] | [mg KOH/g] | [g/mol] | D | [° C.] | [Pa · s] |
| P1 | 210.1 | 139.8 | 40.9 | 405.6 | 101.4 | 32 | 2970 | 11.0 | 69 | 14.0 |
| P2 | 0 | 374.9 | 57.5 | 570.0 | 142.5 | 36 | 2430 | 76.1 | 76 | 38.9 |
| P3 | 142.4 | 287.2 | 16.0 | 481.1 | 206.2 | 77 | 1680 | 2.9 | 62 | 1.9 |
| P4 | 142.4 | 287.2 | 16.0 | 481.1 | 206.2 | 47 | 2455 | 4.9 | 70 | 15.1 |
| P5 | 0 | 396.0 | 17.0 | 510.3 | 218.7 | 57 | 1890 | 3.6 | 69 | 4.4 |

### Preparation of Amorphous Polyesters with OH Groups

Polyester P6

193.75 g of CHA (1.13 mol), 185.88 g of NPG (1.79 mol), 150.94 g of TMP (1.13 mol), 436.60 g of IPA (2.63 mol), 164.46 g of ADA (1.13 mol), and 0.5 g of DBTO catalyst are charged to a 2 L four-neck flask equipped with thermometer, inert gas inlet, stirrer, and reflux condenser. With a stream of nitrogen passed through the flask, and under reflux, the mixture of reactants is heated rapidly to 160° C. Water is distilled off continuously. Subsequently the reaction mixture is heated in stages to 230° C. over the course of 3 to 5 hours, with stirring and with the flow of nitrogen maintained, and stirring is continued at 230° C. until the polyester P6 has an AN of 10 to 15 mg KOH/g. The product is a branched, amorphous, OH-containing polyester P6 whose AN is 15 mg KOH/g. P6 has an OHN of 100 mg KOH/g and a glass transition temperature T_{g} of 23° C. The GPC analysis yields the following values: Mₙ=2162 g/mol; D=7.2. P6 has a melt viscosity η₁ of 2.8 Pa·s at 200° C. The solution viscosity η2 of the polyester P6 at room temperature (P6 solution with 70% nVC and a mixture of Solvesso 100™/Solvenon PM™ 5/1 as solvent) is 27.5 Pa·s (see Table 2).

Polyester P7

The procedure carried out to prepare P6 is repeated, with the composition summarized in Table 2. The key data of the polyester P7 are listed in Table 2.

TABLE 2

| | Composition | | | | | Key polyester data | | | | | | |
|---|---|---|---|---|---|---|---|---|---|---|---|---|
| Poly- | CHA | NPG | TMP | IPA | ADA | AN | OHN | Mₙ | | T_{g} | η₁ | η₂ |
| ester | [g] | [g] | [g] | [g] | [g] | [mg KOH/g] | [mg KOH/g] | [g/mol] | D | [° C.] | [Pa · s] | [Pa · s] |
| P6 | 193.8 | 185.9 | 150.9 | 436.3 | 164.5 | 15 | 100 | 2160 | 7.2 | 23 | 2.8 | 27.5 |
| P7 | 0 | 326.6 | 163.9 | 473.9 | 178.6 | 15 | 108 | 2195 | 16.8 | 25 | 6.3 | 41.6 |

The inventive polymer P 6 has a substantially lower melt viscosity and a substantially lower solution viscosity than the comparative polymer P6.

### Preparation of Water-Dilutable Polyesters

### Polyester

Stage I—Preparation of the OH-containing oligomer 113.4 g of CHA (0.66 mol), 154.3 g of NPG (1.48 mol), 205.3 g of IPA (1.24 mol), and 0.3 g DBTO catalyst are charged to a 2 L four-neck flask equipped with thermometer, inert gas inlet, stirrer, and reflux condenser. With a stream of nitrogen being passed through the flask, and under reflux, the mixture of reactants is heated rapidly to 160° C. Water is distilled off continuously. Subsequently the reaction mixture is heated in stages to 220° C. over the course of 3 to 5 hours, with stirring and with the flow of nitrogen maintained, and is stirred further at 220° C. until the reaction mixture has an AN of 10 to 15 mg KOH/g. The AN of the oligomer is 12 mg KOH/g.
Stage II—Preparation of the polymer P8

The oligomer synthesized above is cooled to 160° C. and then 49.1 g of TMAA (0.41 mol) are added. The temperature is raised to 230° C., and condensation continues under these conditions until the polymer has an AN of 42 to 48 mg KOH/g. The water produced by the polymerization can be stripped off at the end of the reaction by a gentle vacuum, in order to achieve the desired AN. The product is a linear, water-dilutable polyester P8 whose AN is 46 mg KOH/g. P8 has a glass transition temperature T_{g} of 49° C. and a melt viscosity η₁ of 7.7 Pa·s at 200° C. The GPC analysis yields the following values: Mₙ=1370 g/mol; D=3.4 (see Table 3).

Assessment of the hydrolysis stability of P8

A 20% strength aqueous colloidal solution of P8 is prepared, brought to a pH of 8 using N,N-dimethylethanolamine, and stored at 45° C. The time that elapses until the colloidal solution precipitates is taken as a measure of the hydrolysis stability of the polyester (see Table 4).

### Polyester P9

The procedure carried out to prepare P8 is repeated, with the composition summarized in Table 3. The key data of the polyester P9 are listed in Table 3.

TABLE 3

| | | | | | Key polyester data | | | | | |
|---|---|---|---|---|---|---|---|---|---|---|
| | Composition | | | | AN | OHN | | | | |
| Poly- | CHA | NPG | IPA | TMAA | [mg | [mg | Mn | | T_{g} | η₁ |
| ester | [g] | [g] | [g] | [g] | KOH/g] | KOH/g] | [g/mol] | D | [° C.] | [Pa · s] |
| P8 | 113.4 | 154.3 | 205.3 | 79.1 | 46 | 58 | 1380 | 3.4 | 49 | 4.4 |
| P9 | 0 | 490.4 | 451.6 | 174.1 | 47 | 58 | 1250 | 2.3 | 51 | 7.7 |

TABLE 4

| Polyester | Time until aqueous solution precipitates (days) | |
|---|---|---|
| P8 | >30 | days |
| P9 | 17 | days |

### Preparation of Powder Coating Materials

Used as a reference binder (REF) is the polyester resin Uralac® P-862 (T_{g} 58.0° C., AN 35 mg KOH/g) from DSM Resins B.V. To prepare the powder coating materials PL3, PL4, PLS, and PLR, 570.0 g of powder polyester P3, P4, P5 or REF, respectively, are mixed with 30.0 g of commercial curing agent Primid® XL-552 (hydroxylalkylamide from DSM), 300.0 g of Kronos® 2160 titanium dioxide pigment (Kronos), 9.0 g of Resiflow® PV5 flow control agent (Worlée Chemie GmbH) and 2.5 g of benzoin devolatilizer in a universal laboratory mixer (MIT Mischtechnik GmbH), and the mixture is melted and then extruded at 80-100° C. in a twin-screw extruder (MP 19, APV). The resulting extrudate is then fractionated, ground, and screened. The powder coating materials PL3, PL4 and PL5 obtained in this way are subjected to the following tests:

| Test parameter | Test method |
|---|---|
| Flow properties | Fluidizability DIN ISO 8130-5 |
| | Tableting DIN ISO 8130-11 |
| Gel time | DIN ISO8130-6 |

Thereafter the powder coating materials are applied electrostatically to steel test panels (Q-Panel R-36) and baked at 160° C. for 10 minutes. The aim here is to achieve film thicknesses of 60 μm to 80 μm. The resulting coatings are subjected to the following tests:

| Test parameter | Test method |
|---|---|
| Appearance | visual assessment of surfaces |
| Gloss | DIN EN ISO 2813 |
| Impact strength | EN ISO 6272 |
| Impact sensitivity | ASTM D 2794 |
| Elasticity | EN ISO 1520 |
| Weather stability | accelerated weathering (QUV-A) DIN EN ISO 11507 |

The results of the coating tests are summarized in Table 5.

PL3 and PL4 (based on polyesters P3 and P4) are inventive; PL5 and PLR, based on polyester P5 and on the reference binder Ref., are comparative examples.

TABLE 5

| | Test parameter | Test method | PL3 | PL4 | PL5 | PLR |
|---|---|---|---|---|---|---|
| Powder | Flow properties | Fluidizability | 158.2 | 159.7 | 160.4 | 124.6 |
| coating | | Tableting at 180° C. [mm] | 21.5 | 14.5 | 13.5 | 30.5 |
| material | Gel time | Gel time at 180° C. [s] | 201 | 136 | 154 | 173 |
| Test | Appearance | Visual assessment | 2* | 2 | 2 | 2 |
| panels | Gloss | Gloss measurement at 20° | 78 | 66 | 75 | 63 |
| | Impact strength | Reverse impact [kg*cm] | 200 | 200 | 50 | 200 |
| | Impact sensitivity | Impact [kg*cm] | 200 | 200 | 80 | 200 |
| | Elasticity | Erichsen cupping [mm] | 9.4 | 10.5 | 10.1 | 10.6 |
| | Weather stability | Residual gloss after | 71 | 93 | 98 | 93 |
| | | 500 h QUV-A [%] | | | | |

*2 = orange peel, pinholes

The inventive power coating materials PL3 and PL4 exhibit a very good profile of properties. The flow properties are as good as those of powder coating material PL5, based on NPG.

PL3 and PL4 have outstanding mechanical properties; the impact strength, impact sensitivity, and elasticity are very good in comparison to PL 5.

In comparison to PL5, the lower polyester melt viscosity of PL3 and PL4 is an advantage.

### Preparation of high-solids 1-component (1K) coating materials

To prepare the high-solids 1K coating materials 1 K-PL6 and 1 K-PL7, 70% strength solutions of the polyesters P6 and P7 in butyl acetate are prepared accordingly. 80 g of each of the 70% strength polyester solutions are mixed with 14 g of commercial curing agent Luwipal® 066 (melamine condensate from BASF), 4 g of n-butanol and 2 g of p-toluenesulfonic acid catalyst. The resulting solutions (NVC 70%) are applied to glass plates and steel test panels using a bar coater. The aim is for film thicknesses of 40 μm to 50 μm. Thereafter the coated test panels are baked at 140° C. for 30 minutes. The resultant coatings are subjected to the following tests:

| | Test parameter | Test method |
|---|---|---|
| Glass plates | Appearance | visual assessment |
| | | of surfaces |
| | Gloss | DIN EN ISO 2813 |
| | Impact sensitivity | DIN 53157 |
| Steel test | Impact sensitivity | DIN 53157 |
| panels | Elasticity | DIN 53156 |
| | Hydrolysis resistance | Daimler-Chrysler |
| | | Test PBODCC371 |
| | Chemical resistance | Daimler-Chrysler |
| | | Test PBODCC371 |

The results of the coatings tests are summarized in Table 6. 1K-PL6 (based on polyester P6) is inventive, 1K-PL7 (based on polyester P7) serves as a comparative example.

TABLE 6

| | Test parameter | Test method | 1K-PL6 | 1K-PL7 |
|---|---|---|---|---|
| Glass | Appearance | visual assessment | clear | clear |
| plates | Gloss | gloss measurement at 20° | 167 | 175 |
| | Impact | pendulum damping | 230 | 232 |
| | sensitivity | (König) [seconds] | | |
| | | pendulum damping | 164 | 166 |
| | | [swings] | | |
| | Impact | pendulum damping | 226 | 227 |
| | sensitivity | (König) [seconds] | | |
| | Elasticity | pendulum damping | 161 | 164 |
| | Hydrolysis | [swings] | | |
| | resistance | Erichsen cupping [mm] | 8.6 | 8.3 |
| Steel | Chemical | Tₘₐₓ [° C.] - distilled water | 84 | 78 |
| test | resistance | Tₘₐₓ [° C.] - pancreatin in | 69 | 60 |
| panels | | water (50%) | | |
| | | Tₘₐₓ [° C.] - sulfuric acid | 39 | 39 |
| | | (1%) | | |
| | | Tₘₐₓ [° C.] - sodium | 72 | 53 |
| | | hydroxide solution (1%) | | |

The high-solids coating material 1 K-PL6 of the invention exhibits a very good profile of properties. The mechanical properties match those of coating material 1 K-PL7 based on NPG. In particular, CHA shows a marked advantage over NPG in film elasticity, and in hydrolysis and chemical resistance too.

### Preparation of high-solids 2-component (2K) coating materials

To prepare the high-solids 2K coating materials 2K-PL6 and 2K-PL7, 70% strength solutions of the polyesters P6 and P7 in butyl acetate are prepared accordingly. 70 g of each of the 70% strength polyester solutions are mixed with 1 g of solution (10% strength in butyl acetate) of the flow control agent Baysilon® OL17 (polyether from Borchers GmbH), 1 g of dibutyltin dilaurate solution catalyst (5% strength in butyl acetate), 3 g of methoxypropyl acetate, 20 g of commercial curing agent Basonat® HI 190 BS (90% form, polyisocyanate from BASF) and 5 g of butyl acetate. The resulting solutions (NVC 67%) are applied to glass plates and steel test panels using a bar coater. The aim is for film thicknesses of 40 μm to 50 μm. Thereafter the coated test panels are baked at 80° C. for 30 minutes. The resultant coatings are subjected to the following tests:

| | Test parameter | Test method |
|---|---|---|
| Glass plates | Appearance | visual assessment |
| | | of surfaces |
| | Gloss | DIN EN ISO 2813 |
| | Impact sensitivity | DIN 53157 |
| Steel test | Impact sensitivity | DIN 53157 |
| panels | Elasticity | DIN 53156 |
| | Hydrolysis resistance | Daimler-Chrysler |
| | | Test PBODCC371 |
| | Chemical resistance | Daimler-Chrysler |
| | | Test PBODCC371 |

The results of the coatings tests are summarized in Table 7. 2K-PL6 (based on polyester P6) is inventive, 2K-PL7 (based on polyester P7) serves as a comparative example.

TABLE 7

| | Test parameter | Test method | 2K-PL6 | 2K-PL7 |
|---|---|---|---|---|
| Glass | Appearance | visual assessment | clear | clear |
| plates | Gloss | gloss measurement at 20° | 165 | 166 |
| | Impact sensitivity | pendulum damping | 198 | 186 |
| | | (König) [seconds] | | |
| | | pendulum damping | 144 | 134 |
| | | [swings] | | |
| Steel | Impact sensitivity | pendulum damping (König) [seconds] | 196 | 184 |
| test | | pendulum damping [swings] | 140 | 133 |
| panels | | Erichsen cupping [mm] | 10.4 | 10.3 |
| | Elasticity | Tₘₐₓ [° C.] - distilled water | 91 | 55 |
| | Hydrolysis | Tₘₐₓ [° C.] - pancreatin in water (50%) | 39 | 39 |
| | resistance | | | |
| | Chemical | Tₘₐₓ [° C.] - sulfuric acid (1%) | 52 | 50 |
| | resistance | Tₘₐₓ [° C.] - | 49 | 52 |
| | | sodium hydroxide solution (1%) | | |

The high-solids coating material 2K-PL6 of the invention exhibits a very good profile of properties. The mechanical properties are better than in the case of the coating material 2K-PL7 which is based on NPG. In particular, CHA shows a marked advantage over NPG in the hydrolysis resistance of the coating material.

1. A polymer obtained by a process comprising polycondensing or polyadding monomeric compounds, wherein at least one monomeric compound is a C1/C3 cyclohexanediol mixture of hydroxymethylcyclohexanepropanol or its alkoxylated derivative and hydroxymethylcyclohexaneisopropanol or its alkoxylated derivative.

2. The polymer according to claim 1, wherein the C1/C3 cyclohexanediol mixture comprises
5% to 95% by weight of 3 hydroxymethyl-cyclohexanepropanol or 4-hydroxymethylcyclohexanepropanol or a mixture thereof, or its alkoxylated derivatives, and
5% to 95% by weight of 3 hydroxy-methylcyclohexaneisopropanol or 4-hydroxymethylcyclohexaneisopropanol or a mixture thereof, or its alkoxylated derivatives,
the percentages by weight being based on the weight sum of the stated diols.

3. The polymer according to claim 1, wherein the C1/C3 cyclohexanediol mixture of comprises
3-hydroxymethylcyclohexanepropanol,
4-hydroxymethylcyclohexanepropanol,
3-hydroxymethylcyclohexaneisopropanol, and
4-hydroxymethylcyclohexaneisopropanol,
wherein the diols are optionally in the form of alkoxylated derivatives.

4. The polymer according to claim 1, wherein the C1/C3 cyclohexanediol mixture is composed of comprises
5% to 85% by weight of 3-hydroxymethylcyclohexanepropanol
5% to 85% by weight of 4-hydroxymethylcyclohexanepropanol,
5% to 85% by weight of 3-hydroxymethylcyclohexaneisopropanol, and
5% to 85% by weight of 4-hydroxymethylcyclohexaneisopropanol,
wherein the diols are optionally present in the form of alkoxylated derivatives, and the percentages by weight are based on the weight sum of the four diols.

5. The polymer according to claim 1, wherein the C1/C3 cyclohexanediol mixture is obtained by a process comprising hydroformylating 4 vinylcyclohexene to obtain a hydroformylated mixture and subsequently hydrogenating the hydroformylated mixture.

6. A polymer composed of 0.5% to 70% by weight of the C1/C3 cyclohexanediol mixture according to claim 1.

7. The polymer according to claim 1, which is a polyester.

8. The polymer according to claim 1, which is a polycarbonatediol obtained by a process comprising reacting dialkyl carbonates with diols, and eliminating the alcohol).

9. The polymer according to claim 1, which is a polyurethane.

10. The polymer according to claim 1, which is a polyadduct obtained by a process comprising ring-opening polymerizing lactones or lactams.

11. A thermoplastic composition comprising a polymer according to claim 1.

12. (canceled)

13. A coating material, sealant or adhesive comprising a polymer according to claim 1.

14. The coating material, sealant or adhesive according to claim 13, comprising less than 10 parts by weight of water or other organic solvents, and having a boiling point less than 150° C. at 1 bar, per 100 parts by weight of composition.

15. A powder coating material comprising a polymer according to claim 1.

16. A radiation-curable coating material comprising a polymer according to claim 1.

17. A molding comprising the thermoplastic composition according to claim 11.
